(19) United States
(12) Patent Application Publication
(10) Pub. No.: US 2025/0110870 A1
(43) Pub. Date: Apr. 3, 2025

(54) MEMORY SYSTEM AND HOST DEVICE

(71) Applicant: Kioxia Corporation, Tokyo (JP)

(72) Inventors: Naoki HOSOYAMA, Yokohama Kanagawa (JP); Hisashi FUJIKAWA, Ebina Kanagawa (JP)

(21) Appl. No.: 18/820,110

(22) Filed: Aug. 29, 2024

(30) Foreign Application Priority Data
Sep. 29, 2023 (JP) 2023-169396

(51) Int. Cl. G06F 12/02; G06F 13/16

(52) U.S. Cl. CPC G06F 12/0292; G06F 12/0246; G06F 13/1668

(57) ABSTRACT

A controller sets a designated region for a data size, which has consecutive physical addresses, in a storage region of a first memory and stores in a second memory address conversion information in which a head physical address of the consecutive physical addresses is associated with a head logical address of consecutive logical addresses and the data size, in response to a region designation command to which the consecutive logical addresses and the data size are assigned, from a host device. The controller, in response to a read command received from the host device that has a logical address assigned thereto and correspond to data stored in the designated region, determines a physical address corresponding to the logical address assigned to the read command, using the address conversion information stored in the second memory.

### CROSS-REFERENCE TO RELATED APPLICATION(S)

This application is based upon and claims the benefit of priority from Japanese Patent Application No. 2023-169396, filed Sep. 29, 2023, the entire contents of which are incorporated herein by reference.

### FIELD

Embodiments described herein relate generally to a memory system and a host device.

### BACKGROUND

The memory system includes, for example, a non-volatile semiconductor memory and a memory controller that controls the semiconductor memory. The memory controller refers to a logical-to-physical address conversion table, converts a logical address from the host device into a physical address of data to be read, and specifies a read destination in the semiconductor memory when receiving a read command to which the logical address is assigned from the host device.

### DESCRIPTION OF THE DRAWINGS

FIG. 1 is a diagram showing an example of a configuration of an information processing system including a memory system, according to a first embodiment.

FIG. 2 is a circuit diagram showing a configuration example of one block of a memory cell array of the first embodiment.

FIG. 3 is a schematic diagram showing an example of a correspondence relationship between data in a logical address space and data in a physical address space in the memory system of the first embodiment.

FIG. 4 is a schematic diagram showing an example of an operation of the information processing system according to the first embodiment.

FIG. 5 is a schematic diagram showing the example of the operation of the information processing system according to the first embodiment.

FIG. 6 is a schematic diagram showing the example of the operation of the information processing system according to the first embodiment.

FIG. 7 is a schematic diagram showing the example of the operation of the information processing system according to the first embodiment.

FIG. 8 is a schematic diagram showing the example of the operation of the information processing system according to the first embodiment.

FIG. 9 is a schematic diagram showing the example of the operation of the information processing system according to the first embodiment.

FIG. 10 is a sequence diagram showing an example of a procedure of a process in the information processing system according to the first embodiment.

FIG. 11 is a flowchart showing an example of a procedure of a write operation of the memory controller according to the first embodiment.

FIG. 12 is a flowchart showing an example of a procedure of a read operation of the memory controller according to the first embodiment.

FIG. 13 is a schematic diagram showing an example of an operation of an information processing system according to a second embodiment.

FIG. 14 is a schematic diagram showing the example of the operation of the information processing system according to the second embodiment.

FIG. 15 is a schematic diagram showing the example of the operation of the information processing system according to the second embodiment.

FIG. 16 is a sequence diagram showing an example of a procedure of a process in the information processing system according to the second embodiment.

FIG. 17 is a flowchart showing an example of a procedure of a setting process of a designated region of the memory controller according to the second embodiment.

FIG. 18 is a flowchart showing an example of a procedure of a setting process of a designated region of a memory controller according to a first modification example of the second embodiment.

FIG. 19 is a sequence diagram showing an example of a procedure of a process in an information processing system according to a second modification example of the second embodiment.

FIG. 20 is a sequence diagram showing another example of the procedure of the process in the information processing system according to the second modification example of the second embodiment.

FIG. 21 is a schematic diagram showing an example of an operation of an information processing system according to a third embodiment.

FIG. 22 is a schematic diagram showing the example of the operation of the information processing system according to the third embodiment.

FIG. 23 is a sequence diagram showing an example of a procedure of a process in the information processing system according to the third embodiment.

FIG. 24 is a flowchart showing an example of a procedure of a setting process of a designated region of a memory controller according to the third embodiment.

### DETAILED DESCRIPTION

Embodiments provide a memory system and a host device capable of improving read performance by simplifying a logical-to-physical address conversion process via a memory controller.

In general, according to one embodiment, a memory system includes a first memory that is non-volatile, and a controller that has a host interface and a second memory and is configured to control the first memory. The controller, in response to a region designation command received from a host device along with consecutive logical addresses and a data size assigned thereto and a write command, sets a designated region having consecutive physical addresses in a storage region of the first memory, writes data corresponding to the consecutive logical addresses in the consecutive physical addresses, respectively, and stores in the second memory, first address conversion information in which a head physical address of the consecutive physical addresses is associated with a head logical address of the consecutive logical addresses and the data size, and, in response to a first read command received from the host device and the first read command has a logical address assigned thereto that correspond to data stored in the designated region, determines a physical address corresponding to the logical address assigned to the first read command, using the first address conversion information stored in the second memory.

A configuration according to embodiments will be described in detail with reference to the accompanying drawings. The present disclosure is not limited to the embodiments.

### Embodiment 1

Hereinafter, Embodiment 1 will be described in detail with reference to the drawings.

### Configuration Example of Memory System and Host Device

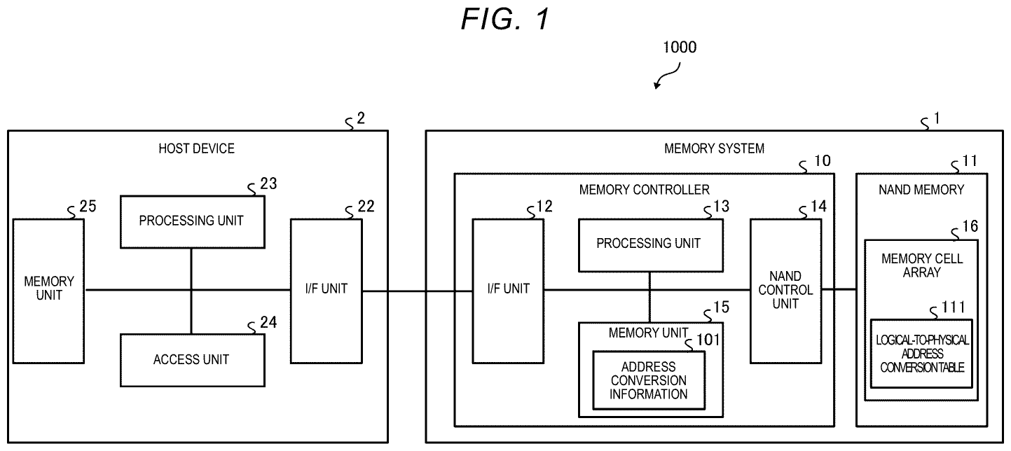

FIG. 1 is a diagram showing an example of a configuration of an information processing system 1000 according to Embodiment 1. The information processing system 1000 according to Embodiment 1 includes a memory system 1 and a host device 2.

The memory system 1 is connected to the host device 2 and functions as an external storage device for the host device 2. The host device 2 may issue an access command to the memory system 1. The access command includes a write command for requesting writing of data and a read command for requesting reading of data. The host device 2 issues these access commands to the memory system 1 by assigning a logical address, which is data location information.

Any interface standard may be adopted as the interface standard for communication between the memory system 1 and the host device 2. Examples of an interface standard that may be adopted include, in addition to the UFS host performance booster (HPB) standard applied to universal flash storage (UFS), a small computer system interface (SCSI) standard, a serial attached SCSI (SAS) standard, a PCI Express standard, and a serial ATA (SATA) standard.

The memory system 1 and the host device 2 may be in a one-to-one correspondence as in the example of FIG. 1, or may be in a many-to-one correspondence. That is, a plurality of memory systems 1 may be connected to the host device 2.

The memory system 1 includes a memory controller 10 and a NAND memory 11, which is a NAND type flash memory. The NAND memory 11 functions as a storage. Meanwhile, as the storage, a memory of a type other than the NAND type flash memory may be adopted. Examples of the memory other than the NAND type include a NOR type flash memory, a resistance random access memory (ReRAM), a magnetoresistive random access memory (MRAM), and a magnetic disk.

The NAND memory 11 includes a memory cell array 16. The memory cell array 16 is configured with a plurality of blocks serving as data erasing units. A plurality of pages, which are units of writing and reading data, are provided in each block. A detailed configuration of the NAND memory 11 will be described below.

The memory controller 10 executes control of all operations of the memory system 1 including data transfer between the host device 2 and the NAND memory 11. The memory controller 10 includes an interface (I/F) unit 12, a processing unit 13, a NAND control unit 14, and a memory unit 15. Some or all of the I/F unit 12, the processing unit 13, and the NAND control unit 14 may be implemented by software, hardware, or a combination thereof. The phrase “element is implemented by software” refers to a central processing unit (CPU) implementing a function of the element according to a computer program.

The I/F unit 12 executes control of communication between the host device 2 and the memory controller 10. For example, the I/F unit 12 transfers an access command from the host device 2 to the NAND control unit 14, or performs an operation setting of the memory controller 10 in response to a setting request from the host device 2. The above function of the I/F unit 12 is implemented by, for example, an I/F circuit that operates under the control of a CPU that is executing a program.

The NAND control unit 14 executes access to the NAND memory 11 in accordance with the access command received from the I/F unit 12. Specifically, the NAND control unit 14 writes data to the NAND memory 11 in accordance with a write command. In addition, the NAND control unit 14 reads data from the NAND memory 11 in accordance with a read command.

As described above, the host device 2 issues these access commands to the memory controller 10 by assigning logical addresses to the data. Meanwhile, the memory controller 10 assigns a physical address to a storage region of the NAND memory 11 to manage data in the NAND memory 11.

The processing unit 13 performs a logical-to-physical address conversion process of converting the logical address and the physical address into each other to specify the data. For example, when predetermined data is written in the NAND memory 11 according to the write command, the processing unit 13 manages the logical address that was assigned to the write command and the physical address of the data write destination in the NAND memory 11 in association with each other. In addition, the processing unit 13 converts the logical address assigned to the read command into a physical address and specifies a data read destination in the NAND memory 11.

Such a logical-to-physical address conversion process via the processing unit 13 is executed by referring to the logical-to-physical address conversion table 111 in which the logical address and the physical address are associated with each other in a one-to-one manner. The logical-to-physical address conversion table 111 is generated, for example, for each page. Therefore, the logical-to-physical address conversion table 111 may have a large size in order to include information corresponding to a wide region extending over a plurality of pages of the storage region of the NAND memory 11, and is stored in the memory cell array 16 of the NAND memory 11, for example. The memory controller 10 appropriately loads the logical-to-physical address conversion table 111 from the NAND memory 11 and performs a process at the time of writing and reading data.

Meanwhile, for some read commands, the address conversion information 101 having a smaller size than that of the logical-to-physical address conversion table 111 may be referred to instead of the logical-to-physical address conversion table 111. The address conversion information 101 can be stored in the memory unit 15 of the memory controller 10 because its size is sufficiently small. The detailed configuration of the address conversion information 101 will be described later.

The processing unit 13 is, for example, the above-described CPU, that is, a processor, and the above function of the processing unit 13 is implemented, for example, by the CPU executing a program.

The memory unit 15 is configured with a register or a memory. Any type of memory may be adopted as the memory unit 15. As the memory of the memory unit 15, for example, a dynamic random access memory (DRAM) or a static random access memory (SRAM) may be adopted. The above-described address conversion information 101 is stored in a state in which the address conversion information 101 is always loaded in the memory unit 15, which is a DRAM, an SRAM, or the like.

The host device 2 is a computer such as a personal computer, a server, a portable information device, or an AV device. For example, an operating system (OS) and one or more applications are executed in the host device 2. The host device 2 includes an I/F unit 22, a processing unit 23, an access unit 24, and a memory unit 25. Some or all of the I/F unit 22, the processing unit 23, the access unit 24, and the memory unit 25 may be implemented by software, hardware, or a combination thereof.

The I/F unit 22 executes control of communication between the memory system 1 and the host device 2. For example, the I/F unit 22 transmits an access command from the host device 2 to the memory controller 10, and also allows data exchange between the host device 2 and the memory controller 10. The above function of the I/F unit 22 is implemented by, for example, an I/F circuit that operates under the control of a CPU that is executing a program. The CPU here is, for example, a CPU provided in the host device 2 configured as a computer.

The host device 2 according to Embodiment 1 may issue a region designation command to the memory controller 10 in addition to the write command, the read command, and the like. The region designation command is a command for causing the memory controller 10 to secure a predetermined region in the storage region of the NAND memory 11. That is, with the region designation command, the host device 2 can designate the predetermined region in the NAND memory 11 via the memory controller 10. The region designation command may be included in the access command. The I/F unit 22 transmits the region designation command from the host device 2 to the memory controller 10.

The processing unit 23 manages a logical address to be assigned to the access command such as the write command and the read command. The logical address is assigned a number with respect to a management unit for managing data in a predetermined size such as 4 kB. As described above, the logical address is location information used by the host device 2 to designate a location of data in the memory system 1. An address space implemented by the logical address is also referred to as a logical address space. The logical address space is provided by the memory system 1 to the host device 2.

As described above, the physical address is location information used by the memory controller 10 to designate a location of data in the NAND memory 11, and an address space implemented by the physical address is also referred to as a physical address space.

The processing unit 23 also manages a logical address to be assigned to the region designation command. For example, the region designation command occupies a wide region of the address space like that of an OS, and a logical address corresponding to data with a low rewrite frequency or data requiring high-speed access is assigned. Occupying a wide region of the address space refers to, for example, a large data size, e.g., gigabytes of data. The processing unit 23 determines a timing of issuing the region designation command and selects the logical address to be assigned to the region designation command.

The processing unit 23 is, for example, the CPU of the host device 2, that is, a processor, and the above function of the processing unit 23 is implemented, for example, by the CPU executing a program.

The memory unit 25 is configured with a register or a memory. Any type of memory may be adopted as the memory unit 25. A volatile memory such as a DRAM or an SRAM may be adopted as the memory of the memory unit 25.

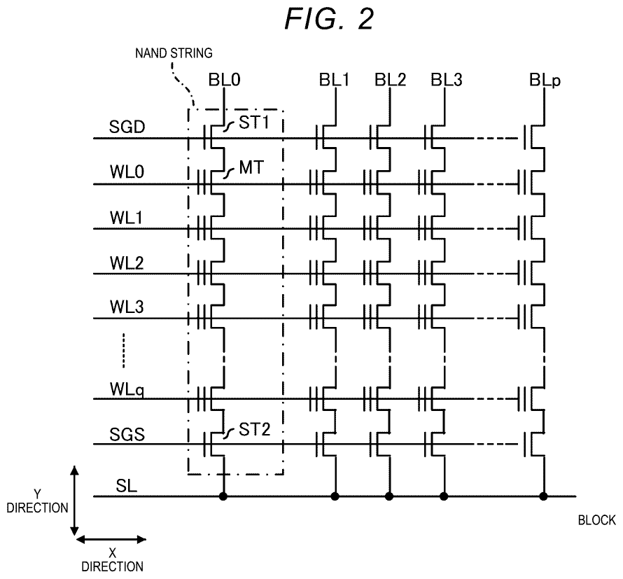

Next, a detailed configuration of the memory cell array 16 provided in the NAND memory 11 will be described with reference to FIG. 2. FIG. 2 is a circuit diagram showing a configuration example of one block of the memory cell array 16 according to Embodiment 1.

As shown in FIG. 2, each block includes (p+1) NAND strings arranged in order along the X direction. Here, p is an integer of 0 or more. In the select transistors ST1 provided in each of the (p+1) NAND strings, the drains are connected to the bit lines BL0 to BLp and gates are commonly connected to the select gate line SGD. Here, p is an integer of 1 or more. In addition, the select transistor ST2 has sources connected in common to the source line SL and gates connected in common to the select gate line SGS.

Each memory cell transistor MT is configured with, for example, a metal oxide semiconductor field effect transistor (MOSFET) having a stacked gate structure formed on a semiconductor substrate. The stacked gate structure includes a charge storage layer (for example, a nitride film (SiN) or a floating gate) formed on a semiconductor substrate with a tunnel oxide film interposed therebetween, and a control gate electrode formed on the charge storage layer with a gate insulating film interposed therebetween. In the memory cell transistor MT, the threshold voltage changes according to the number of electrons stored in the charge storage layer, and data corresponding to the difference in the threshold voltage is stored. That is, the memory cell transistor MT stores a quantity of charges corresponding to data in the charge storage layer, which is a floating gate or the like.

Specifically, the memory cell transistor MT is charged with electrons using the peripheral circuit (not shown) provided in the NAND memory 11 such that the threshold voltage reaches a target value according to the data. The peripheral circuit includes a charge pump, a row decoder, a sense amplifier, and a column decoder. The memory cell transistor MT may be configured to store 1-bit data or may be configured to store 2-bit or more multi-valued data.

In each of the NAND strings, (p+1) memory cell transistors MT are disposed such that the current path of each of the memory cell transistors MT is connected in series between the source of the select transistor ST1 and the drain of the select transistor ST2. The control gate electrodes are connected to each of the word lines WL0 to WLq in order from the memory cell transistor MT located closest to the drain side. Therefore, the drain of the memory cell transistor MT connected to the word line WL0 is connected to the source of the select transistor ST1, and the source of the memory cell transistor MT connected to the word line WLq is connected to the drain of the select transistor ST2.

The word lines WL0 to WLq are commonly connected to the control gate electrode of the memory cell transistor MT across the NAND strings in the block. That is, the control gate electrodes of the memory cell transistors MT in the same row in the block are connected to the same word line WL. The (p+1) memory cell transistors MT connected to the same word line WL are treated as one or more pages, and data is written and read for each page.

That is, for example, according to a storage method in which 2-bit data is stored in the memory cell transistor MT, (p+1) memory cell transistors MT connected to the same word line WL are treated as two pages of an upper page and a lower page.

Consecutive physical addresses are assigned to one page. In addition, consecutive physical addresses are assigned to one page provided in one block.

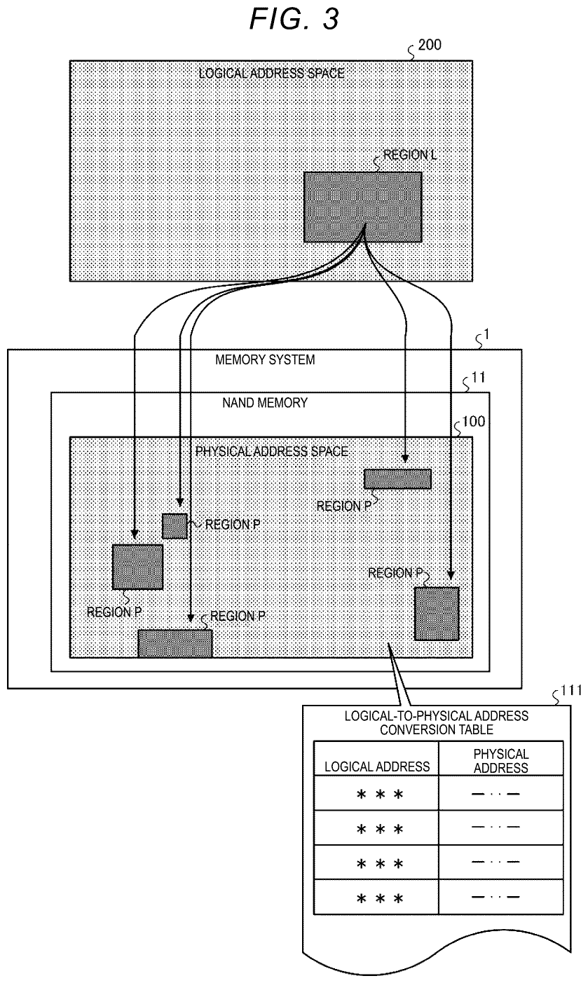

Next, a correspondence relationship between data in the logical address space 200 and data in the physical address space 100 will be described with reference to. FIG. 3 is a schematic diagram showing an example of a correspondence relationship between data in the logical address space 200 and data in the physical address space 100 in the memory system 1 according to Embodiment 1.

As shown in FIG. 3, it is assumed that a predetermined region L of the logical address space 200 is a region having consecutive logical addresses. The data specified by these consecutive logical addresses may be distributed in a plurality of regions P having inconsecutive physical addresses from each other in the physical address space 100. This is because the block, which is a data write destination, is determined regardless of the logical address assigned to the write command, and the data is written in ascending order of pages.

Thereby, at the time of writing and reading data, the memory controller 10 loads the logical-to-physical address conversion table 111 from the NAND memory 11 and performs each process as described above. In the logical-to-physical address conversion table 111, a logical address and a physical address corresponding to the logical address are associated in a one-to-one manner and stored.

The memory controller 10 stores the physical address of the newly written data and the logical address designated by the host device 2 in the logical-to-physical address conversion table 111 in association with each other at the time of writing the data. In addition, at the time of reading data, the memory controller 10 refers to the logical-to-physical address conversion table 111 loaded from the NAND memory 11, converts the logical address designated from the host device 2 into a physical address of a data read destination, and specifies data to be read.

Meanwhile, the address conversion information 101 described above, which is stored in the memory controller 10, is configured to have a small size by adopting a different data configuration instead of a one-to-one correspondence between the logical address and the physical address. Hereinafter, an operation example of the information processing system 1000 according to Embodiment 1 will be shown, and a detailed configuration of the address conversion information 101 will be described.

### Operation Example of Information Processing System

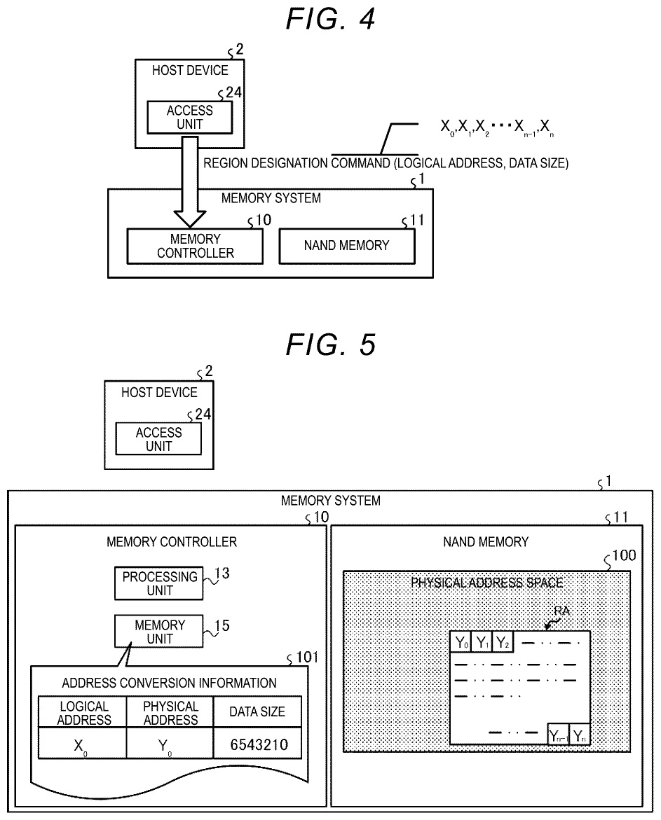

FIGS. 4 to 9 are schematic diagrams showing the example of the operation of the information processing system 1000 according to Embodiment 1.

As shown in FIG. 4, the host device 2 issues a region designation command to the memory system 1, for example, when issuing a write command. The region designation command is provided with one or more consecutive logical addresses (X₀, X₁, X₂, . . . , Xₙ₋₁, and Xₙ) and a data size required in a region to be designated. Here, n is an integer of 3 or more. For convenience of explanation, it is assumed that the region designation command is issued prior to the write command, but the region designation command may be issued at the same time as the write command.

As shown in FIG. 5, when the processing unit 13 of the memory controller 10 receives the region designation command from the host device 2, the processing unit 13 sets a predetermined region having a data size designated by the region designation command and consecutive physical addresses (Y₀, Y₁, Y₂, . . . , Yₙ₋₁, and Yₙ) corresponding to a logical address assigned to the region designation command in a one-to-one manner as a designated region RA in the physical address space 100 of the NAND memory 11. The setting of the designated region RA may be performed, for example, via the NAND control unit 14.

In addition, the processing unit 13 generates address conversion information 101 in which the data size that was assigned to the region designation command, a head logical address (X₀) of the logical addresses, and a head physical address (Y₀) of the designated region RA are associated, and stores the address conversion information 101 in the memory unit 15 in the memory controller 10.

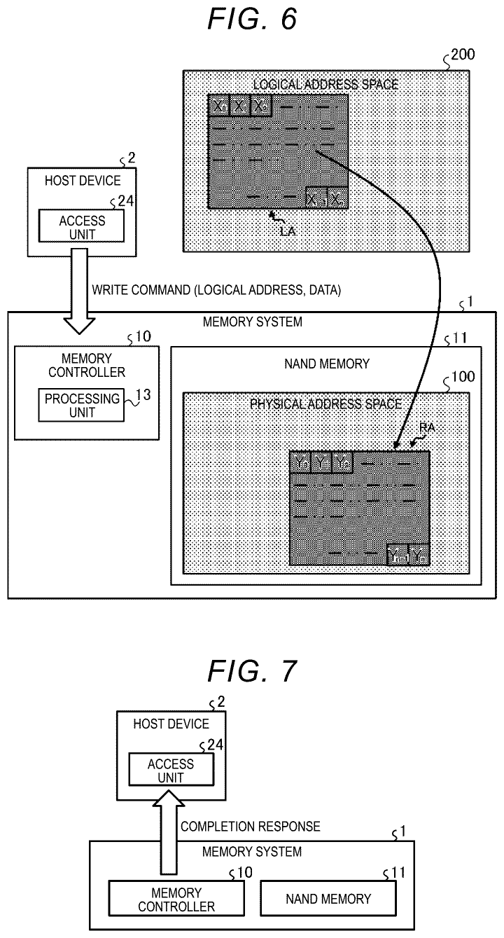

As shown in FIG. 6, the host device 2 issues a write command to the memory system 1 by assigning predetermined data indicated by the logical address assigned to the region designation command in FIG. 4. The data corresponding to the logical address is present, for example, in a predetermined region LA in the logical address space 200. When the write command is issued after the above region designation command, the same logical address as the logical address assigned to the region designation command in FIG. 4 is assigned to the write command in order to specify the data.

When the processing unit 13 of the memory controller 10 receives the region designation command from the host device 2, for example, the data from the host device 2 is written into the designated region RA set in the physical address space 100 of the NAND memory 11 via the NAND control unit 14.

As shown in FIG. 7, the memory controller 10 transmits a completion response to the host device 2 when the data write operation is completed.

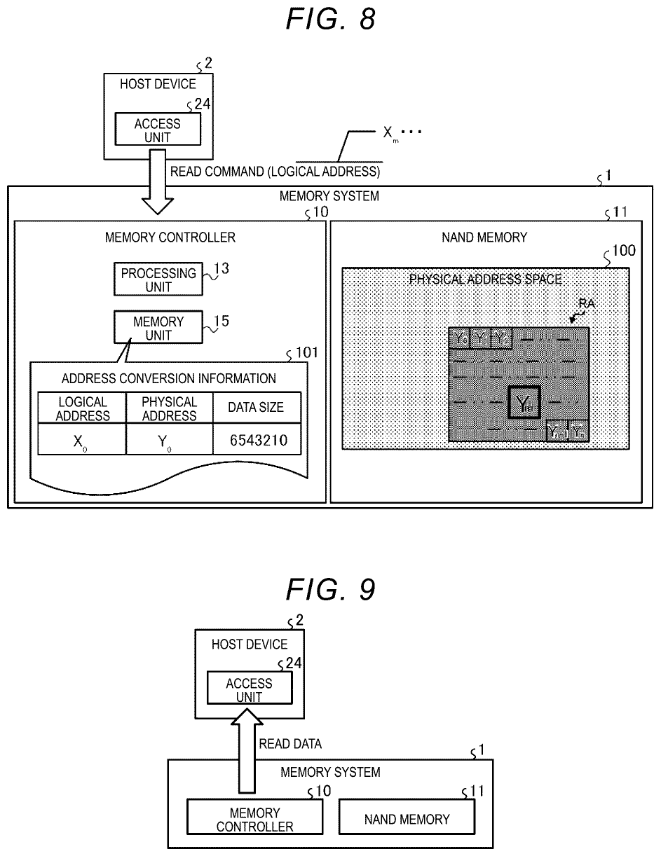

As shown in FIG. 8, the host device 2 assigns one or more logical addresses designating any data in the designated region RA to the memory system 1 and issues a read command. That is, the logical addresses (Xₘ, . . . ) assigned at this time are assumed to be included in the above-mentioned logical addresses (X₀, X₁, X₂, . . . , Xₙ₋₁, and Xₙ).

When the processing unit 13 of the memory controller 10 receives a read command to which a logical address designating data in the designated region RA is assigned, the processing unit 13 performs a logical-to-physical address conversion process of converting the logical address designated by the read command into a physical address with reference to the address conversion information 101 loaded in the memory unit 15.

More specifically, the processing unit 13 refers to the address conversion information 101, specifies the head logical address (X₀) of the logical addresses (X₀, X₁, X₂, . . . , Xₙ₋₁, and Xₙ) described above, and subtracts the head logical address (X₀) from the logical address (Xₘ) designated by the read command. The processing unit 13 refers to the address conversion information 101, specifies the head physical address (Y₀) of the designated region RA, and adds the difference of the logical addresses (X₀and Xₘ) to the head physical address (Y₀). Thereby, a physical address (Yₘ) corresponding to the logical address (Xₘ) designated by the read command is specified. When there are a plurality of logical addresses designated by the read command, the above-described logical-to-physical address conversion process is repeated.

As shown in FIG. 9, the memory controller 10 reads the data specified by the physical address obtained in the above-described logical-to-physical address conversion process from the NAND memory 11 and transmits the data to the host device 2.

In this way, by setting the designated region RA having consecutive physical addresses corresponding to the logical address in the physical address space 100 of the NAND memory 11, it is possible to manage the data in the designated region RA by using the small-sized address conversion information 101.

When a rewrite instruction is issued from the host device 2 for the data in the designated region RA set in the NAND memory 11, the data for which the rewrite instruction is issued is rewritten in a predetermined region outside the designated region RA in the physical address space 100. In that case, the management method of the data may be returned to the management with the above-described logical-to-physical address conversion table 111.

Meanwhile, when a frequent rewrite instruction is issued for the data in the designated region RA, the address conversion information 101 does not function. Therefore, the host device 2 according to Embodiment 1 may, for example, select data having a rewrite frequency equal to or less than a predetermined value as described above and write the selected data to the designated region RA. In addition, since the logical-to-physical address conversion process can be simplified by the address conversion information 101, data for which high-speed access is required may be written to the designated region RA.

As data with a low rewrite frequency, for example, data that occupies a wide region of an address space, such as an OS, is considered. In addition, data related to the OS is often required to be accessed at high speed. As a case where the data of the OS is rewritten, for example, a timing of updating the OS is considered.

In this manner, by designating data having a large size, such as the OS data, as the write target to the designated region RA, the configuration of Embodiment 1 in which a part of the large-sized logical-to-physical address conversion table 111 is replaced with the small-sized address conversion information 101 is suitably applied. At this time, the address conversion information 101 covers a wide range of regions over a plurality of pages in the address space.

The setting of the designated region RA may be performed for a plurality of regions. In this case, the host device 2 may issue the region designation command each time, and the memory controller 10 may set the designated region RA one by one, or the host device 2 may designate a plurality of regions with one region designation command. As the number of designated regions RA, a total size of the address conversion information 101 corresponding to these designated regions RA may be set as an upper limit, which is a size storable in the memory unit 15 in the memory controller 10.

### Process Example of Information Processing System

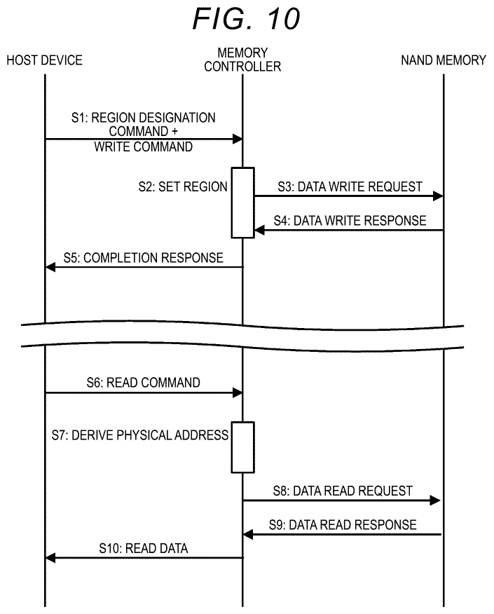

Next, a process example of the information processing system 1000 according to Embodiment 1 will be described with reference to FIGS. 10 to 12.

First, a process example of the entire information processing system 1000 will be described with reference to FIG. 10. FIG. 10 is a sequence diagram showing an example of a procedure of a process in the information processing system 1000 according to Embodiment 1.

As shown in FIG. 10, the host device 2 issues the region designation command to which one or more consecutive logical addresses and the data size are assigned, to the memory controller 10 (step S1). The host device 2 may issue a write command to which data corresponding to the logical address is assigned at the same time.

When the region designation command is received from the host device 2, the processing unit 13 of the memory controller 10 sets the designated region RA in the physical address space 100 of the NAND memory 11, generates the address conversion information 101 in which the head physical address of the designated region RA, the head address of the logical addresses assigned to the region designation command from the host device 2, and the data size are associated with each other, and stores the address conversion information 101 in the memory unit 15 (step S2).

In addition, the NAND control unit 14 of the memory controller 10 requests the NAND memory 11 to write the data, which is assigned to the write command, to the set designated region RA, in accordance with the write command received from the host device 2 (step S3). The NAND memory 11 writes data in the designated region RA, and then transmits a write response to the memory controller 10 (step S4). In response to this, the memory controller 10 transmits a completion response to the host device 2 (step S5).

Thereafter, the host device 2 transmits a read command to which a logical address corresponding to the data of the designated region RA is assigned to the memory controller 10 at a predetermined time (step S6).

The processing unit 13 of the memory controller 10 performs a logical-to-physical address conversion process based on the address conversion information 101 of the memory unit 15 to convert the logical address, which is assigned to the read command, into a physical address (step S7).

The NAND control unit 14 of the memory controller 10 designates the physical address derived by the processing unit 13 and requests the NAND memory 11 to read data (step S8). The NAND memory 11 transmits a read response to the memory controller 10 together with the read data (step S9). The memory controller 10 transmits the data read from the NAND memory 11 to the host device 2 (step S10).

With the above, the process of the information processing system 1000 according to Embodiment 1 is completed.

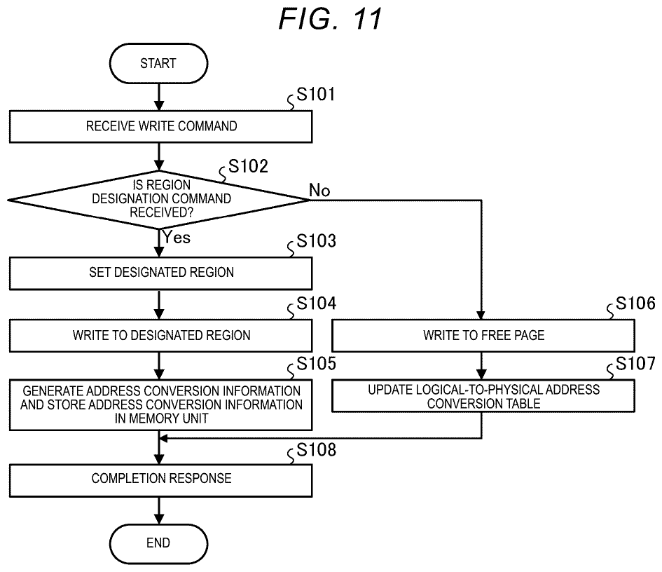

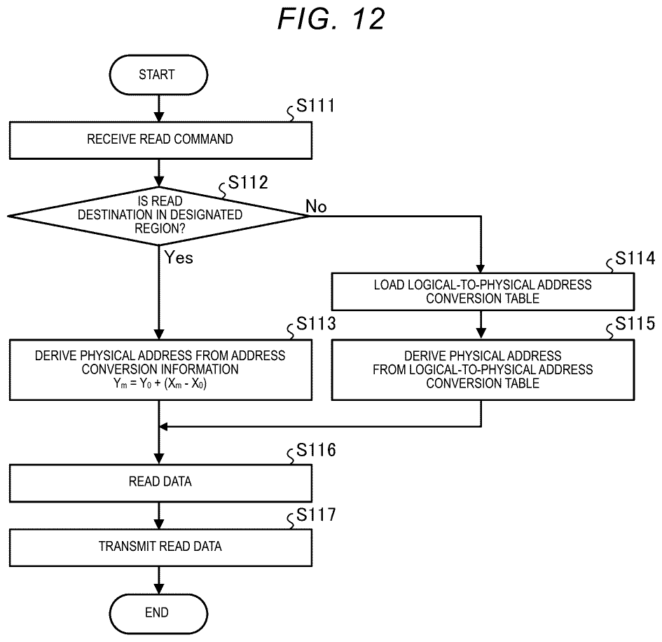

Next, a write operation via the memory controller 10 according to Embodiment 1 will be described with reference to FIG. 11. FIG. 11 is a flowchart showing an example of a procedure of a write operation of the memory controller 10 according to Embodiment 1. In FIG. 11, explanation will be given including a case where the region designation command is issued at the same time as the write command.

As shown in FIG. 11, the I/F unit 12 of the memory controller 10 receives a write command from the host device 2 (step S101).

When the I/F unit 12 receives the region designation command in association with the write command (step S102: Yes), the processing unit 13 of the memory controller 10 sets the designated region RA in the storage region of the NAND memory 11 (step S103).

The NAND control unit 14 writes the data that was assigned to the write command from the host device 2 to the designated region RA of the NAND memory 11 (step S104).

In addition, the processing unit 13 generates address conversion information 101 in which a head logical address of the logical addresses that were assigned to the region designation command, the data size, and a head physical address of the set designated region RA are associated, and stores the address conversion information 101 in the memory unit 15 (step S105).

Meanwhile, when the region designation command associated with the write command is not received (step S102: No), the NAND control unit 14 writes the data, which was assigned to the write command from the host device 2, to a predetermined region of the NAND memory 11 (step S106). A write destination of the data at this time is determined in ascending order from among free pages in which the data is not written. The processing unit 13 loads the logical-to-physical address conversion table 111 from the NAND memory 11, for example, and then specifies a page to be written with data.

In addition, the processing unit 13 stores the physical address of the data write destination and the logical address that was assigned to the write command in association with each other in the logical-to-physical address conversion table 111 loaded from the NAND memory 11 (step S107). The updated logical-to-physical address conversion table 111 is stored in the predetermined region of the NAND memory 11 again.

When any of the above processes are completed, the memory controller 10 transmits a completion response to the host device 2 (step S108).

As described above, the write operation via the memory controller 10 according to Embodiment 1 is completed.

When the write command and the region designation command are received at the same time, the timing for generating the address conversion information 101 may be after the designated region RA is set and before data is written into the designated region RA.

Next, a read operation via the memory controller 10 according to Embodiment 1 will be described with reference to FIG. 12. FIG. 12 is a flowchart showing an example of a procedure of a read operation of the memory controller 10 according to Embodiment 1.

As shown in FIG. 12, the I/F unit 12 of the memory controller 10 receives a read command from the host device 2 (step S111). The processing unit 13 of the memory controller 10 determines whether the read destination designated by the read command is in the designated region RA (step S112).

Whether the read command designates the designated region RA as the read destination may be determined, for example, by the logical address, which is assigned to the read command, referring to the address conversion information 101 that is loaded in the memory unit 15 of the memory controller 10.

That is, the processing unit 13 refers to the address conversion information 101 of the memory unit 15, and determines the logical addresses from the head to the end, which correspond to the designated region RA, based on the head logical address (X₀), which is included in the address conversion information 101 and corresponds to the designated region RA, and the data size of the designated region RA. The processing unit 13 determines whether the logical address assigned to the read command is included in the logical addresses determined in this manner. That is, when the head logical address (X₀)≤ the logical address (Xₘ) of the read command ≤ the end logical address (Xₙ), it is determined that the logical address of the read command designates the designated region RA. Here, m is an integer of 0 or more.

When the read destination designated by the read command is the designated region RA (step S112: Yes), the processing unit 13 refers to the address conversion information 101 of the memory unit 15 and derives a physical address from the logical address assigned to the read command (step S113).

More specifically, the processing unit 13 derives a physical address corresponding to the logical address of the read command by offsetting a difference between a head logical address corresponding to the designated region RA and a logical address assigned to the read command from a head physical address of the designated region RA. That is, the physical address of the read destination is specified by performing an offset calculation such as the corresponding physical address (Yₘ)=the head physical address (Y₀)+(the logical address (Xₘ) of the read command-the head logical address (X₀)).

Meanwhile, when the read destination designated by the read command is not the designated region RA (step S112: No), the processing unit 13 loads the logical-to-physical address conversion table 111 from the NAND memory 11, for example, via the NAND control unit 14 (step S114). In addition, the processing unit 13 refers to the logical-to-physical address conversion table 111 to derive the physical address of the read destination (step S115).

The NAND control unit 14 reads data from the storage region of the NAND memory 11 specified by the physical address derived from the address conversion information 101 or the logical-to-physical address conversion table 111 (step S116). The I/F unit 12 transmits the read data to the host device 2 (step S117).

As described above, the read operation via the memory controller 10 according to Embodiment 1 is completed.

### Overview

In a NAND type flash memory or the like, data is written in units of pages, and the data is erased in units of blocks. In addition, data cannot be written additionally to a page in which data was written previously, and the data is written in ascending order of pages regardless of a logical address assigned to a write command.

Therefore, in data management in the memory controller, a logical-to-physical address conversion table is used in which a logical address designated by the host device is associated with a physical address that specifies a predetermined location in a storage region in the NAND memory. Since the size of the logical-to-physical address conversion table may be as large as 1/500 to 1/1000 of the storage capacity of the memory system, it is not practical to always load the logical-to-physical address conversion table in the SRAM or the like in the memory controller. For example, the logical-to-physical address conversion table is stored in the NAND memory and is loaded into the memory controller and used at the time of reading data, or the like.

Meanwhile, it takes a predetermined time to load the logical-to-physical address conversion table from the NAND memory. Therefore, each time data is read, the operation of the memory system is delayed by loading the logical-to-physical address conversion table, and the read performance of the memory system is reduced.

According to the memory system 1 of Embodiment 1, when the memory controller 10 receives the region designation command to which one or more consecutive logical addresses and the data size are assigned from the host device 2, the memory controller 10 sets the designated region RA for the data size, which has consecutive physical addresses, in the storage region of the NAND memory 11, and stores the address conversion information 101 in which the head physical address of the consecutive physical addresses is associated with the head logical address of the consecutive logical addresses and the data size in the memory unit 15.

As a result, the address conversion information 101 that may be used for the logical-to-physical address conversion process can be obtained with a significantly smaller amount of information than, for example, the logical-to-physical address conversion table 111. Therefore, the address conversion information 101 can be constantly loaded in, for example, the memory unit 15 in the memory controller 10.

According to the memory system 1 of Embodiment 1, when the memory controller 10 receives the read command to which a logical address corresponding to data in the designated region RA is assigned from the host device 2, the memory controller 10 specifies a physical address offset from a head physical address of the address conversion information 101 as a physical address corresponding to the logical address assigned to the read command, based on the logical address assigned to the read command.

In this way, when data is read from the designated region RA, the logical-to-physical address conversion process can be performed by referring to the address conversion information 101 that is loaded in the memory unit 15. Therefore, the process of loading the logical-to-physical address conversion table 111 from the NAND memory 11 can be omitted. As a result, since the logical-to-physical address conversion process performed by the memory controller 10 can be simplified, the delay at the time of reading data can be reduced and the read performance of the memory system I can be improved.

According to the memory system 1 of Embodiment 1, the memory controller 10 offsets a difference between the logical address assigned to the read command and the head logical address from the head physical address to specify the physical address corresponding to the logical address assigned to the read command. By using the address conversion information 101, the physical address corresponding to the logical address can be derived by a simple offset calculation as described above.

According to the host device 2 of Embodiment 1, a logical address to be assigned to the region designation command is determined based on whether a rewrite frequency of data specified by the logical address is equal to or less than a predetermined value. That is, a logical address specifying data having a rewrite frequency equal to or less than a predetermined value is assigned to the region designation command.

As described above, when a rewrite instruction is issued from the host device 2 for the data in the designated region RA, the data is rewritten in a predetermined region outside the designated region RA, and is managed again using the logical-to-physical address conversion table 111. By applying the region designation command to the data having the rewrite frequency equal to or less than a predetermined value, it is possible to prevent the generated address conversion information 101 from functioning in a short period of time.

Further, as described above, for example, by targeting data such as OS data having a data size that is one or more gigabytes and having a high read frequency, the above configuration in which a partial information of the logical-to-physical address conversion table 111 is assigned to the address conversion information 101 can be more effectively utilized.

### Embodiment 2

In Embodiment 1 described above, the logical-to-physical address management is performed by using the address conversion information 101 for the data, for example, having a low rewrite frequency. However, even such data may be rewritten at a low frequency, and if this occurs repeatedly, the function of the address conversion information 101 is impaired.

In Embodiment 2, an information processing system capable of recovering the function of the address conversion information 101 when the function is impaired will be described with the configuration of Embodiment 1 described above as a premise.

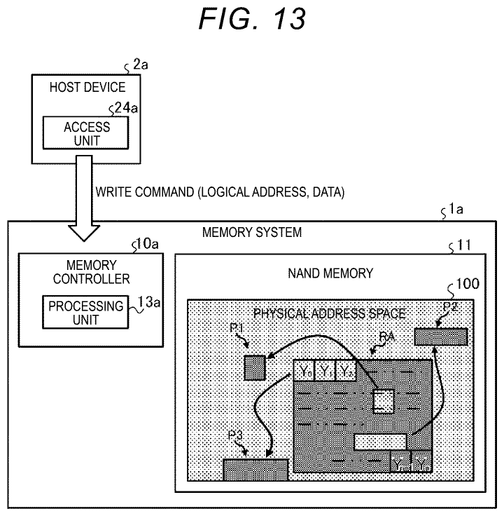

Hereinafter, an information processing system according to Embodiment 2 will be described with reference to FIGS. 13 to 18. In the following figures, the same symbol is attached to the same configuration as that in above-described Embodiment 1, and the description may be omitted.

### Operation Example of Information Processing System

FIGS. 13 to 15 are schematic diagrams showing the example of the operation of the information processing system according to Embodiment 2.

As shown in FIG. 13, the information processing system of Embodiment 2 includes a host device 2a and a memory system la, and the memory system la includes a memory controller 10a and a NAND memory 11. A designated region RA is set in the physical address space 100 of the NAND memory 11, and data is stored.

In the example of FIG. 13, it is assumed that the necessity of rewriting the data in the designated region RA arises in the host device 2a. The access unit 24a of the host device 2a issues a write command to which a logical address corresponding to any of the data written in the designated region RA and data for rewriting are assigned to the memory controller 10.

When a logical address corresponding to the written data in the designated region RA is assigned to the received write command, the memory controller 10a writes the data assigned to the write command in a predetermined region other than the designated region RA in the physical address space 100 of the NAND memory 11. The memory controller 10a that received the write command may determine that the logical address assigned to the write command corresponds to the written data in the designated region RA by referring to the address conversion information 101 in the memory unit 15.

For example, when logical addresses (X₀, X₁, and X₂) of predetermined data in the designated region RA are assigned to the write command from the host device 2a, the memory controller 10a writes the data assigned to the write command in the region P1 outside the designated region RA. At this time, the correspondence between the logical addresses (X₀, X₁, and X₂) and the physical addresses (Y₀, Y₁, and Y₂) is added to the logical-to-physical address conversion table in the NAND memory 11, and the data specified by these addresses is managed by the logical-to-physical address conversion table.

In addition, the processing unit 13a of the memory controller 10a invalidates data specified by the physical addresses (Y₀, Y₁, and Y₂) in the designated region RA, which correspond to the logical addresses (X₀, X₁, and X₂). Further, a portion of the address conversion information 101 related to the logical addresses (X₀, X₁, and X₂) and the physical addresses (Y₀, Y₁, and Y₂) is also invalidated.

Similarly, when a write command is transmitted from the host device 2a with a logical address for specifying another data in the designated region RA being assigned, the memory controller 10a writes the data of the write command to other regions P2, P3, and the like in the physical address space 100 of the NAND memory 11, and invalidates the corresponding data in the designated region RA and the corresponding portion of the address conversion information 101.

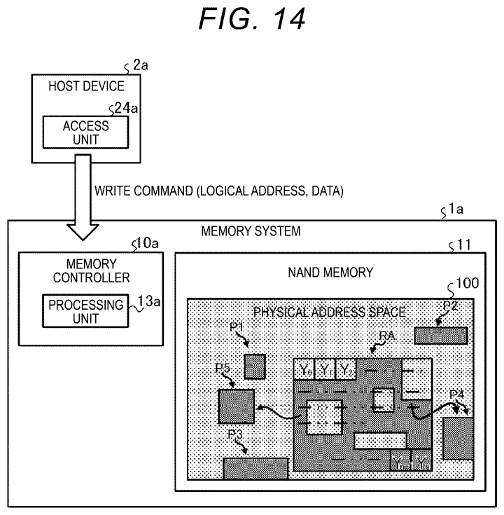

As shown in FIG. 14, after that, when a write command for designating data in the designated region RA is issued from the host device 2a, the predetermined data in the designated region RA is rewritten into other regions P4, P5, and the like, the number of invalid regions in the designated region RA is increased, and the number of invalid portions of the address conversion information 101 is also increased.

Such a situation is not preferable in a configuration in which a part of the functions of the logical-to-physical address conversion table 111 is replaced with the address conversion information 101 in order to simplify the logical-to-physical address conversion process. Therefore, in Embodiment 2, a process is performed to put the data, which is rewritten from the designated region RA to other regions P1 to P5, under the management of the newly generated address conversion information.

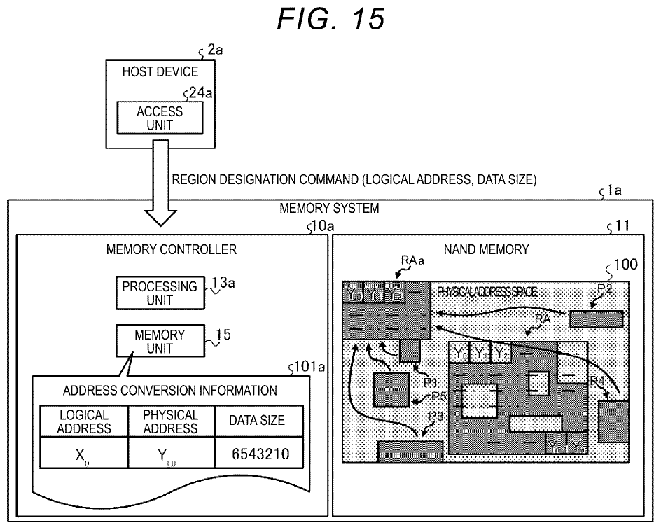

As shown in FIG. 15, the host device 2a issues a region designation command to which a logical address designating data written previously in the NAND memory 11 and a data size are assigned to the memory controller 10a.

When the logical address corresponding to the previously written data in the NAND memory 11 is assigned to the received region designation command, the memory controller 10a sets a region, which is a predetermined region for the data size assigned in the region designation command and has consecutive physical addresses, as a designated region RAa in the physical address space 100 of the NAND memory 11, and writes the written data in the NAND memory 11 to the newly set designated region RAa. The fact that the logical address assigned to the region designation command corresponds to the written data may be checked by the memory controller 10a that received the region designation command loading the logical-to-physical address conversion table from the NAND memory 11 and collating the logical address with the physical address corresponding to the logical address.

For example, when logical addresses (X₀, X₁, X₂, . . . ) of data rewritten from the designated region RA to other regions P1 to P5 are assigned to the region designation command from the host device 2a, the memory controller 10a reads the data of the regions P1 to P5 from the NAND memory 11 once, writes the data to the newly set designated region RAa having consecutive physical addresses (Y_{L0}, Y_{L1}, Y_{L2}, . . . ), and invalidates the data of the regions P1 to P5. In addition, the processing unit 13a of the memory controller 10a newly generates address conversion information 101a in which the head logical address (X₀) of the logical addresses (X₀, X₁, X₂, . . . ) assigned to the region designation command and the data size are associated with the head physical address (Y_{L0}) of the physical addresses (Y_{L0}, Y_{L1}, Y_{L2}, . . . ) of the newly set designated region RAa, and stores the address conversion information 101a in the memory unit 15.

With the above process, the data rewritten in the NAND memory 11 can be managed by the newly generated address conversion information 101a instead of the address conversion information 101 in which the function is impaired by the rewriting of the data in the designated region RA.

The host device 2a according to Embodiment 2 may appropriately issue a region designation command for designating the written data at any time. Alternatively, the region designation command may be issued under a condition that the data in the designated region RA is rewritten a predetermined number of times.

When the function of the address conversion information 101 is impaired, a plurality of regions may be set for the designated region RAa to be newly set with the size of the address conversion information 101a corresponding to this being a maximum size storable in the memory unit 15 in the memory controller 10.

In addition, in the configuration of Embodiment 2, when the address conversion information 101a is generated, some data under the management of the logical-to-physical address conversion table is transferred under the management of the address conversion information 101a, and the old information of some data remains in the logical-to-physical address conversion table.

Meanwhile, when the access command is received from the host device 2a, the memory controller 10a refers to the address conversion information 101a with priority before referring to the logical-to-physical address conversion table. Therefore, there is no issue in the process of the memory controller 10a. In addition, the processing unit 13a of the memory controller 10a may perform a process such as invalidating the logical-to-physical address conversion table in a portion that overlaps with the address conversion information 101a as appropriate in response to an instruction from the host device 2a or when there is no access from the host device 2a for a certain period of time.

### Process Example of Information Processing System

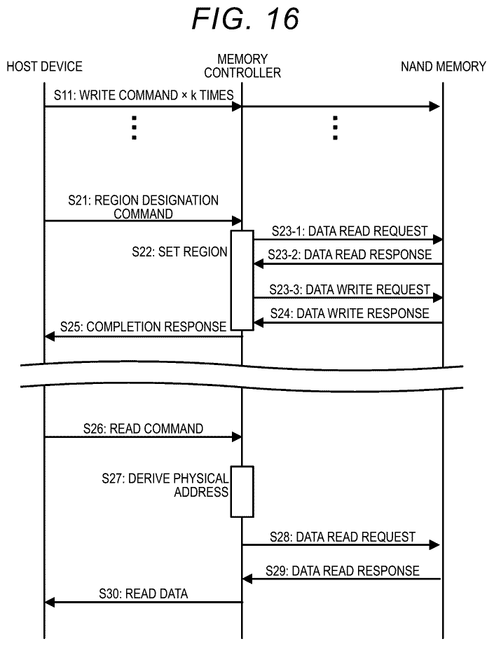

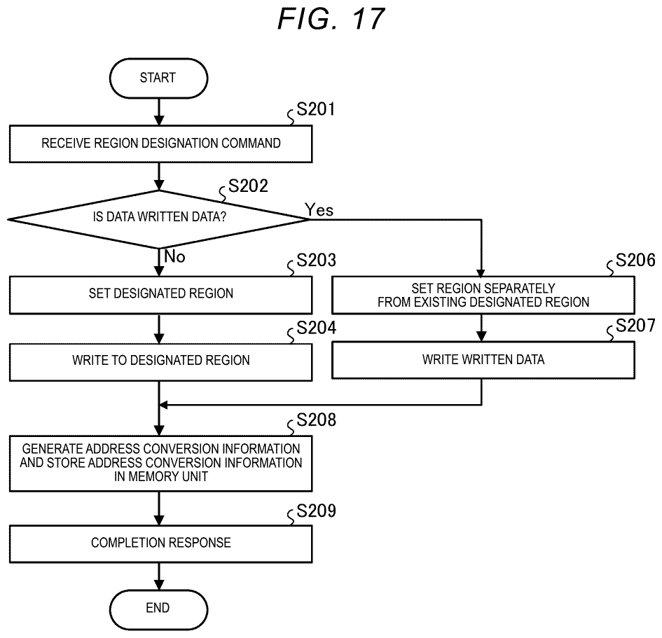

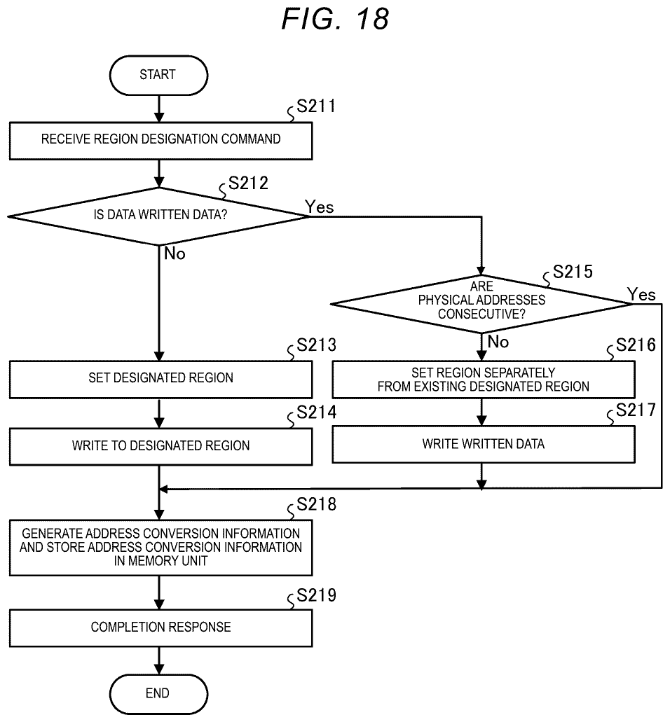

Next, a process example of the information processing system according to Embodiment 2 will be described with reference to FIGS. 16 and 17.

First, a process example of the entire information processing system of Embodiment 2 will be described with reference to FIG. 16. FIG. 16 is a sequence diagram showing an example of a procedure of a process in the information processing system according to Embodiment 2. It is assumed that, before the sequence shown in FIG. 16, for example, the designated region RA is set in the physical address space 100 of the NAND memory 11 by the sequence in the first half, or the like of FIG. 10 in above-described Embodiment 1, and data is written in the designated region RA.

As shown in FIG. 16, a write command for designating data in the designated region RA is issued a plurality of times (for example, k times: k is an integer of 1 or more) from the host device 2a to the memory controller 10a, and the data in the designated region RA is rewritten (step S11).

Thereafter, at any time, a region designation command for designating the written data is issued from the host device 2a to the memory controller 10a (step S21). The memory controller 10a sets a predetermined region for data size, which is assigned to the region designation command, in the NAND memory 11 as the designated region RAa.

In addition, the memory controller 10a generates address conversion information 101a in which the head physical address of the newly set designated region RAa is associated with the head address of the logical addresses assigned to the region designation command from the host device 2a and the data size, and stores the address conversion information 101a in the memory unit 15 (step S22).

In addition, the memory controller 10a requests the NAND memory 11 to read the written data designated by the region designation command (step S23-1). The NAND memory 11 reads the written data in response to a read request from the memory controller 10a (step S23-2).

The memory controller 10a requests the NAND memory 11 to write the data read from the NAND memory 11 into the newly generated designated region RAa (step S23-3). The NAND memory 11 writes data, and then transmits a write response to the memory controller 10a (step S24). In response to this, the memory controller 10a transmits a completion response to the host device 2a (step S25).

After that, when a read command for designating data of the designated region RAa is received from the host device 2a, the processes performed by the memory controller 10a in steps S26 to S30 are substantially the same as the processes performed by the memory controller 10a in steps S6 to S10 in FIG. 10 of Embodiment 1 described above.

That is, when a read command for designating the data in the designated region RAa is received (step S26), the memory controller 10a performs a logical-to-physical address conversion process by referring to the address conversion information 101a that is to be loaded in the memory unit 15 (step S27), designates the derived physical address, reads the data from the NAND memory 11 (steps S28 and S29), and transmits the data to the host device 2a (step S30).

With the above, the process of the information processing system according to Embodiment 2 is completed.

Next, a setting process of designated regions RA and RAa via the memory controller 10a according to Embodiment 2 will be described with reference to FIG. 17. FIG. 17 is a flowchart showing an example of a procedure of the setting process of the designated regions RA and RAa of the memory controller 10a according to Embodiment 2.

As shown in FIG. 17, when the processing unit 13a of the memory controller 10a receives a region designation command from the host device 2a (step S201), the processing unit 13a determines whether data designated by the region designation command is already written in the NAND memory 11 (step S202).

When the data designated by the region designation command is not the written data (step S202: No), the processes in steps S203 and S204 performed by the memory controller 10a are the same as the processes in steps S103 and S104 in FIG. 11 of above-described Embodiment 1. In this case, the memory controller 10a is assumed to receive a write command to which data to be written in the designated region RA is assigned at a predetermined time.

That is, the memory controller 10a sets the designated region RA in the NAND memory 11 (step S203) and writes new data into the designated region RA (step S204). In addition, the processing unit 13a generates the address conversion information 101 for specifying the data of the designated region RA, and stores the address conversion information 101 in the memory unit 15 (step S208).

Meanwhile, when the data designated by the region designation command is the written data (step S202: Yes), the memory controller 10a sets a new designated region RAa in the NAND memory 11 (step S206), and reads the written data designated by the region designation command from a predetermined region of the NAND memory 11 and writes the read data into the newly set designated region RAa (step S207).

Thereafter, the processing unit 13a generates the address conversion information 101a for specifying the data of the designated region RAa, and stores the address conversion information 101a in the memory unit 15 (step S208).

When any of the above processes are completed, the memory controller 10a transmits a completion response to the host device 2a (step S209).

As described above, the setting process of the designated regions RA and RAa via the memory controller 10a according to Embodiment 2 is completed.

### Overview

According to the memory system la of Embodiment 2, when the logical address, which is assigned to the region designation command from the host device 2a, is a logical address for specifying the data written in the NAND memory 11, the memory controller 10a stores the address conversion information 101a in the memory unit 15 and writes the written data in the designated region RAa. As a result, even when the data of the original designated region RA is rewritten and the function of the address conversion information 101 is impaired, the data can be managed by the newly generated address conversion information 101a.

For the rest, the memory system 1a of Embodiment 2 has the same effects as those of the memory system 1 of Embodiment 1 described above.

In above-described Embodiment 2, when the designated region RAa is designated, it is assumed that the host device 2 issues a region designation command by assigning a logical address for designating data that is previously written in the NAND memory 11 and that is stored in the designated region RA. Meanwhile, the data designated by the logical address assigned to the region designation command when the designated region RAa is designated may be written data stored in the region other than the designated region RA. In this case, the written data, which was originally not managed by the address conversion information 101, can be stored in the designated region RAa and then managed by the newly generated address conversion information 101a.

### Modification Example 1

Next, a memory system of Modification Example 1 according to Embodiment 2 will be described with reference to FIG. 18. The memory system of Modification Example 1 is different from the memory system la of Embodiment 2 described above in that a data rewrite process may be omitted when a region designation command for designating the written data is received.

FIG. 18 is a flowchart showing an example of a procedure of a setting process of designated regions RA and RAa of a memory controller according to Modification Example 1 of Embodiment 2.

As shown in FIG. 18, the same process as the process in FIG. 17 of above-described Embodiment 2 is performed except for the process in step S215 of the memory controller of Modification Example 1.

That is, when the memory controller of Modification Example 1 receives a region designation command from the host device (step S211), the memory controller determines whether data designated by the region designation command is already written (step S212). When the data designated by the region designation command is not the written data (step S212: No), the processes in steps S213, S214, and S218 are the same as the processes in steps S203, S204, and S208 in FIG. 17 of above-described Embodiment 2.

When the data designated by the region designation command is the written data (step S212: Yes), the memory controller determines whether the physical addresses corresponding to the written data in the NAND memory are consecutive (step S215).

When the physical addresses corresponding to the written data are inconsecutive (step S215: No), the memory controller of Modification Example 1 sets a new designated region (corresponding to the designated region RAa of Embodiment 2) in the NAND memory as in the memory controller 10a of Embodiment 2 described above (step S216), and reads the written data designated by the region designation command from a predetermined region of the NAND memory and writes the data into the newly set designated region (step S217). In addition, address conversion information (corresponding to the address conversion information 101a of Embodiment 2) for specifying data of the newly set designated region is generated and stored in the memory unit (step S218).

Meanwhile, when the physical addresses corresponding to the written data are consecutive (step S215: Yes), the memory controller of Modification Example 1 skips the processes in steps S216 and S217, generates address conversion information (corresponding to the address conversion information 101a of Embodiment 2) in which the head physical address of the physical addresses is associated with the head logical address of the logical addresses, which are assigned to the region designation command, and the data size, and stores the address conversion information in the memory unit (step S218).

That is, the memory controller of Modification Example 1 generates only the address conversion information for managing these data without performing the rewrite process for the data having the consecutive physical addresses.

When any of the above processes are completed, the memory controller transmits a completion response to the host device (step S219).

As described above, the setting process of the designated regions via the memory controller according to Modification Example 1 is completed.

According to the memory system of Modification Example 1, when the logical address assigned to the region designation command is a logical address for specifying the written data and the written data has consecutive physical addresses, the memory controller does not set a new designated region in the NAND memory and does not write the written data again.

In this way, when the written data has consecutive physical addresses, these data can be managed by the address conversion information without setting another designated region again and rewriting the written data. Therefore, the unnecessary rewrite process can be omitted for these data, and the performance of the memory system of Modification Example 1 can be further improved.

According to the memory system of Modification Example 1, when the data is not rewritten as described above, the memory controller stores the address conversion information in which the head physical address and the data size of the region designation command are associated with the head logical address of the consecutive physical addresses the written data has in the memory unit. In this way, by generating the address conversion information for the written data having the consecutive physical addresses, the subsequent logical-to-physical address conversion process can be simplified, and the read performance of the memory system can be improved.

For the rest, the memory system of Modification Example 1 has the same effects as those of the memory system la of Embodiment 2 described above.

### Modification Example 2

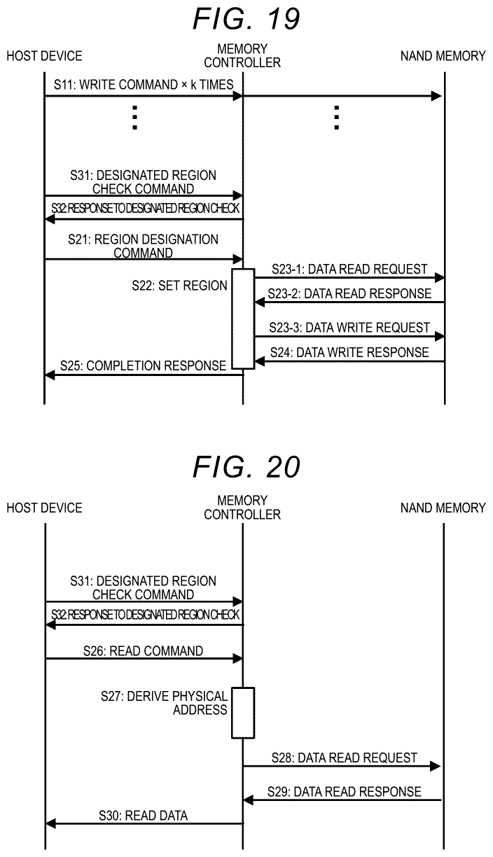

Next, the information processing system of Modification Example 2 according to Embodiment 2 will be described with reference to FIGS. 19 and 20. The information processing system of Modification Example 2 is different from that of Embodiment 2 described above in that the host device issues a command for checking a state in the NAND memory to the memory controller.

More specifically, the host device of Modification Example 2 issues a designated region check command for checking a state of a designated region in the NAND memory to the memory controller at a predetermined time. By using the designated region check command, the host device can check whether the function of the address conversion information is impaired by rewriting data from the designated region, or the like.

Thereby, the host device can determine whether to issue the region designation command after checking whether the function of the address conversion information is impaired. When it is checked that the function of the address conversion information is impaired, the host device may issue a region designation command by designating the written data, for example, as in above-described Embodiment 2.

Alternatively, by issuing the designated region check command, the host device can determine whether to issue a read command designating data in the designated region after checking whether the function of the address conversion information is impaired. When it is checked that the function of the address conversion information is impaired, the host device may issue a region designation command by designating the written data before issuing the read command, for example, as in above-described Embodiment 2.

FIG. 19 is a sequence diagram showing an example of a procedure of a process in an information processing system according to Modification Example 2 of Embodiment 2. FIG. 19 shows an example when the host device issues a designated region check command in order to determine whether to issue a region designation command for designating the written data.

As shown in FIG. 19, a write command for designating data in the designated region is issued k times, for example, from the host device to the memory controller, and the data in the designated region is rewritten (step S11).

Thereafter, in order to determine whether to issue the region designation command by designating the written data, the host device assigns a logical address corresponding to the written data to be designated by the region designation command before issuing the region designation command, and issues a designated region check command to the memory controller (step S31).

Since the designated region check command is a command for checking the current state of the designated region, a logical address, which is at least once written in the designated region and has a history in address conversion information, is assigned to the designated region check command. Therefore, the memory controller checks whether the function of the address conversion information for the portion corresponding to the logical address assigned to the designated region check command is impaired, that is, whether the address conversion information for that portion is invalidated, and then responds to the host device with the check result (step S32). Thereby, the host device can ascertain a state of the designated region and can determine whether to issue the region designation command by designating the written data.

Here, in the example of FIG. 19, it is assumed that the host device determines to issue the region designation command for designating the written data, based on the response obtained from the memory controller. In this case, the processes in the subsequent steps S21 to S25 are the same as the processes in the steps S21 to S25 shown in FIG. 16 of above-described Embodiment 2.

That is, the host device issues the region designation command by designating the written data (step S21), and the memory controller sets a new designated region (step S22), reads the written data from the NAND memory (steps S23-1 and S23-2), and writes the data to the newly set designated region (steps S23-3, S24, and S25).

With the above, the process of the information processing system according to Modification Example 2 is completed.

FIG. 20 is a sequence diagram showing another example of the procedure of the process in the information processing system according to Modification Example 2 of Embodiment 2. FIG. 20 shows an example when the host device issues a designated region check command in order to check the impaired state of the address conversion information when designating data in the designated region to issue a read command.

As shown in FIG. 20, the host device assigns a logical address corresponding to the data to be designated by the read command before issuing the read command designating the data in the designated region, and issues a designated region check command to the memory controller (step S31). The memory controller checks whether the function of the address conversion information for the portion corresponding to the logical address assigned to the designated region check command is impaired, and then responds to the host device with the check result (step S32). Thereby, the host device can ascertain the state of the designated region, and can determine whether issuing the region designation command for designating, for example, the written data which is the read target is necessary before issuing the read command.

Here, in the example of FIG. 20, it is assumed that the host device determines that issuing the region designation command for designating the written data is unnecessary, based on the response obtained from the memory controller. In this case, the processes in the subsequent steps S26 to S30 are the same as the processes in the steps S26 to S30 shown in FIG. 16 of above-described Embodiment 2.

That is, the host device designates the data of the designated region and issues the read command (step S26), the memory controller derives a physical address of a read destination based on the address conversion information (step S27), reads data from a read destination of a specified NAND memory (steps S28 and S29), and transmits the data to the host device (step S30).

With the above, the process of the other example in the information processing system of Modification Example 2 is completed.

According to the memory system of Modification Example 2, the memory controller checks a state of the address conversion information related to a predetermined logical address assigned to a designated region check command to which the logical address is assigned and transmits a check result to the host device when the memory controller receives the designated region check command from the host device. Thereby, the host device can check the state of the designated region before issuing a region designation command for designating the written data as in Embodiment 2 or a read command for designating the data of the designated region.

According to the host device of Modification Example 2, the host device transmits a designated region check command to which the logical address corresponding to the written data is assigned to the memory controller before transmitting the region designation command to which the logical address specifying the written data is assigned.

Thereby, the host device can determine, for example, whether to issue a region designation command for designating the written data as in Embodiment 2. Therefore, issuing of an unnecessary region designation command can be prevented, and the load of the entire information processing system can be reduced.

According to the host device of Modification Example 2, the host device transmits a designated region check command to which a logical address, which is included in the consecutive logical addresses assigned to the region designation command and is to be assigned to a read command to which the logical address is assigned, is assigned to the memory controller before transmitting the read command.

Thereby, the host device can determine whether the data of the read destination of the read command to be issued hereafter is still managed by the address conversion information.

When the function of the address conversion information of the portion related to the data of the read destination is impaired, the host device may issue, for example, a region designation command for designating the written data as in Embodiment 2 described above before issuing the read command. Therefore, the data, which was replaced under the management of the logical-to-physical address conversion table, can be managed by the address conversion information again, and the read command can be issued, so that the delay in reading data can be reduced, and the read performance of the memory system can be improved.

### Embodiment 3

In Embodiments 1 and 2 described above, for example, a region designation command is issued by designating data with a low rewrite frequency, and the data is placed under the management of the address conversion information. In addition, at this time, for example, a wide range of region such as data of an OS is designated, and the advantage of transferring a part of the function of the logical-to-physical address conversion table to the address conversion information is enhanced.

In Embodiment 3, the data for which high-speed access is required is mainly targeted, and the logical-to-physical address conversion process for the predetermined data having a very limited size is simplified. In the configuration of Embodiment 3, the rewrite frequency does not matter.

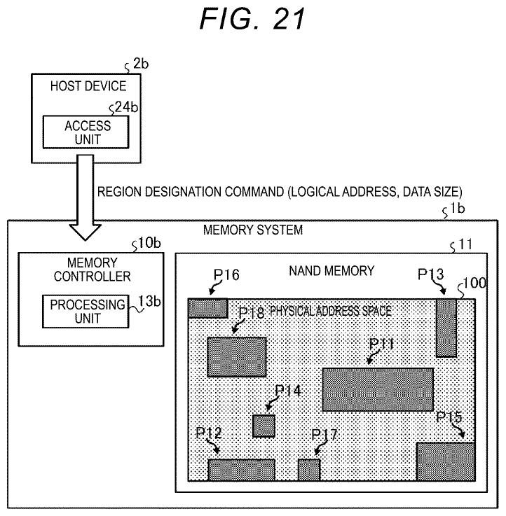

Hereinafter, an information processing system according to Embodiment 3 will be described with reference to FIGS. 21 to 24. In the following figures, the same symbol is attached to the same configuration as that in above-described Embodiments 1 and 2, and the description may be omitted.

### Operation Example of Information Processing System

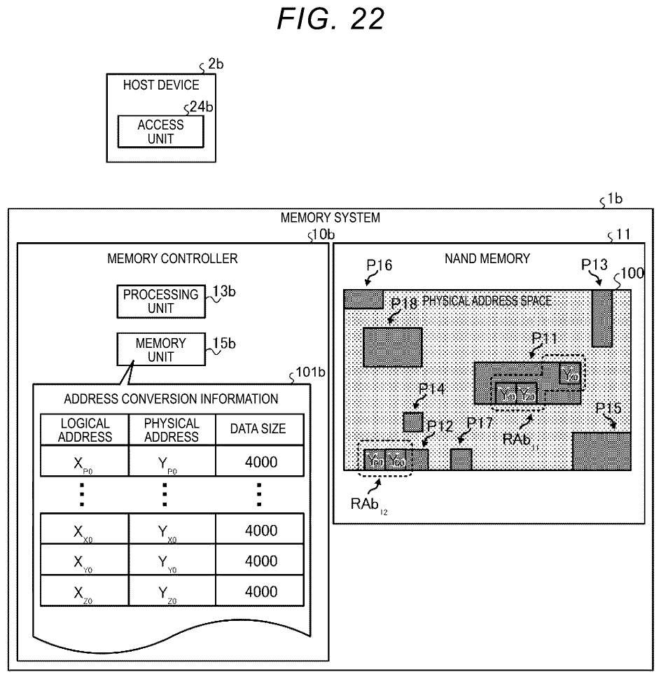

FIGS. 21 and 22 are schematic diagrams showing the example of the operation of the information processing system according to Embodiment 3.

As shown in FIG. 21, the information processing system of Embodiment 3 includes a host device 2b and a memory system 1b, and the memory system 1b includes a memory controller 10b having the processing unit 13b, and a NAND memory 11. Data is stored in some of the regions P11 to P18 in the physical address space 100 of the NAND memory 11. The data is managed by the logical-to-physical address conversion table stored in the NAND memory 11.

The host device 2b according to Embodiment 3 may select data, for which access at a predetermined speed or higher is required, from the data written in the regions P11 to P18, and the access unit 24b of the host device 2b may issue a region designation command for the data. At this time, a logical address of data which is selected by the host device 2b and for which high-speed access is required and a data size of the data are assigned to the region designation command.

As shown in FIG. 22, the processing unit 13b of the memory controller 10b sets a region in which data corresponding to these logical addresses is stored as a designated region RAb in the physical address space 100 of the NAND memory 11. In addition, among the physical addresses corresponding to the data, the processing unit 13b generates address conversion information 101b in which the corresponding logical address and the data size are associated with the physical address for each one predetermined logical unit, and stores the address conversion information 101b in the memory unit 15b.

Here, as the one logical unit, any data size may be set in advance, and may be, for example, 4 kB, which is the minimum management unit of data, that is, the logical address assignment unit. In this case, the address conversion information 101b has a configuration that may be said to be a reduced version of the logical-to-physical address conversion table stored in the NAND memory 11, in which the physical address is associated with each logical address assigned to the region designation command.

For example, when logical addresses (X_{P0} and X_{Q0}) of a part of the data stored in the region P12 of the NAND memory 11 are assigned to the region designation command from the host device 2b, the processing unit 13b of the memory controller 10b sets a write region of data specified by the physical addresses (Y_{P0} and Y_{Q0}) corresponding to these logical addresses (X_{P0} and X_{Q0}), that is, a part of the region P12, as the designated region RAb₁₂. At this time, the logical addresses (X_{P0} and X_{Q0}) assigned to the region designation command may be consecutive logical addresses or may be inconsecutive logical addresses.

In addition, the processing unit 13b extracts the logical addresses for each one logical unit, and generates the address conversion information 101b by associating the physical addresses corresponding to these logical addresses with a data size representing one logical unit. In this case, when one logical unit is the size of one logical address, in the address conversion information 101b, the corresponding physical addresses (Y_{P0} and Y_{Q0}) are associated for each of the logical addresses (X_{P0} and X_{Q0}) and stored.

In addition, for example, when logical addresses (X_{X0}, X_{Y0}, and X_{Z0}) of a part of the data stored in the region P11 of the NAND memory 11 are assigned to the region designation command from the host device 2b, the processing unit 13b of the memory controller 10b sets a write region of data specified by the physical addresses (Y_{X0}, Y_{Y0}, and Y_{Z0}) corresponding to these logical addresses (X_{X0}, X_{Y0}, and X_{Z0}), that is, a part of the region P11, as the designated region RAbn. At this time, the logical addresses (X_{X0}, X_{Y0}, and X_{Z0}) assigned to the region designation command may be consecutive logical addresses or may be inconsecutive logical addresses.

In addition, the processing unit 13b extracts the logical addresses for each one logical unit, and generates the address conversion information 101b by associating the physical addresses corresponding to these logical addresses with a data size representing one logical unit. In this case, when one logical unit is the size of one logical address, in the address conversion information 101b, the corresponding physical addresses (Y_{X0}, Y_{Y0}, and Y_{Z0}) are associated for each of the logical addresses (X_{X0}, X_{Y0}, and X_{Z0}) and stored.

A plurality of regions and a plurality of data may be set for the designated region RAb of Embodiment 3 with the size of the address conversion information 101b corresponding to this being a maximum size storable in the memory unit 15b.

In addition, also in the configuration of Embodiment 3, when the address conversion information 101b is generated, some data under the management of the logical-to-physical address conversion table is transferred under the management of the address conversion information 101b, and the old information of some data remains in the logical-to-physical address conversion table.

Meanwhile, in this case as well, the memory controller 10b refers to the address conversion information 101b with priority before referring to the logical-to-physical address conversion table, and corresponds to the access command from the host device 2b. Therefore, there is no issue in the process of the memory controller 10b. The processing unit 13b of the memory controller 10b may also perform a process such as invalidating the logical-to-physical address conversion table in a portion overlapping with the address conversion information 101b, as appropriate.

### Process Example of Information Processing System

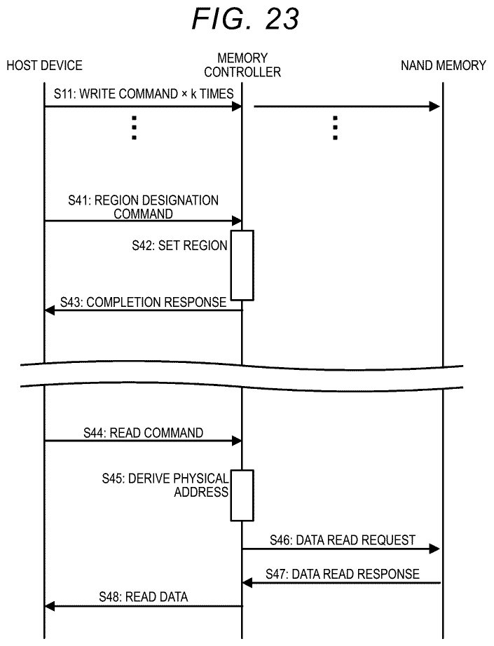

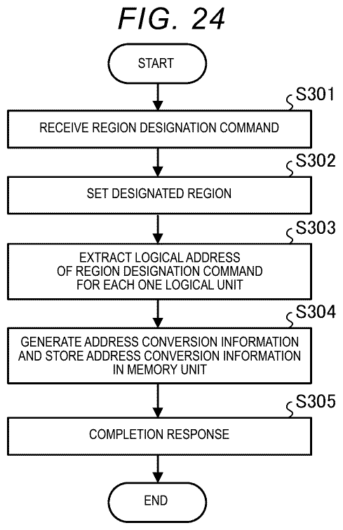

Next, a process example of the information processing system according to Embodiment 3 will be described with reference to FIGS. 23 and 24.

First, a process example of the entire information processing system of Embodiment 3 will be described with reference to FIG. 23. FIG. 23 is a sequence diagram showing an example of a procedure of a process in the information processing system according to Embodiment 3.

As shown in FIG. 23, a write command to which a predetermined logical address is assigned is issued, for example, k times from the host device 2b to the memory controller 10b, and data is written into a plurality of regions of the NAND memory 11 (step S11).

Thereafter, at any time, a region designation command for designating the written data is issued from the host device 2b to the memory controller 10b (step S41). The memory controller 10b sets a region in which data in the NAND memory 11, which is designated by the logical address assigned to the region designation command, is written as a designated region RAb (step S42). In addition, the memory controller 10b generates the address conversion information 101b in which the data size for one logical unit is associated with the corresponding physical address for each one logical unit of the logical address that was assigned to the region designation command, and stores the address conversion information 101b in the memory unit 15b.

When the above process is completed, the memory controller 10b transmits a completion response to the host device (step S43).

In addition, at any time, when a read command for designating the designated region RAb is received from the host device 2b (step S44), the memory controller 10b refers to the address conversion information 101b that is loaded in the memory unit 15b, and derives a physical address corresponding to the logical address (step S45).

Further, the memory controller 10b designates the derived physical address and makes a data read request to the NAND memory 11 (step S46). The NAND memory 11 transmits the read data to the memory controller 10b and performs a read response (step S47). The memory controller 10b transmits the data read from the NAND memory 11 to the host device 2b (step S48).

With the above, the process of the information processing system according to Embodiment 3 is completed.

Next, a setting process of the designated region RAb via the memory controller 10b according to Embodiment 3 will be described with reference to FIG. 24. FIG. 24 is a flowchart showing an example of a procedure of the setting process of the designated region RAb of the memory controller 10b according to Embodiment 3.

When a region designation command to which a logical address designating the written data and a data size are assigned is received from the host device 2b (step S301), the memory controller 10b loads the logical-to-physical address conversion table from the NAND memory 11, converts the logical address assigned to the region designation command into a physical address, and sets a region in the NAND memory 11 specified by the physical address as the designated region RAb (step S302).

In addition, the memory controller 10b extracts the logical address assigned to the region designation command for each one logical unit (step S303), generates the address conversion information 101b in which the corresponding physical address is associated with the data size for one logical unit, and stores the address conversion information 101b in the memory unit 15b (step S304). When the above process is completed, the memory controller 10b transmits a completion response to the host device 2b (step S305).

As described above, the setting process of the designated region RAb via the memory controller 10b according to Embodiment 3 is completed.

### Overview

According to the memory system 1b of Embodiment 3, when the memory controller 10b receives a region designation command to which one or more logical addresses for specifying data written in the NAND memory 11 and a data size are assigned from the host device 2b, the memory controller 10b sets a region to which the written data is written as the designated region RAb, extracts a physical address corresponding to the logical address for each one predetermined logical unit, and stores the address conversion information 101b in which the physical address corresponding to the logical address is associated with the logical address and a data size for one logical unit in the memory unit 15b.

As a result, the host device 2b can individually designate data for which high-speed access is required in one logical unit, and can efficiently speed up access. In this case, the logical address assigned to the region designation command and the physical address specifying the designated region may be consecutive or inconsecutive.

In addition, since data management is performed in one logical unit, for example, even when data is rewritten in the designated region RAb, the function of the address conversion information 101b can be maintained by updating only a portion corresponding to the data.

According to the memory system 1b of Embodiment 3, when the memory controller 10b receives the read command to which a logical address corresponding to data in the designated region RAb is assigned from the host device 2b, the memory controller 10b specifies a physical address corresponding to the logical address assigned to the read command by referring to the address conversion information 101b.

As a result, the logical-to-physical address conversion process performed by the memory controller 10b can be simplified, and the delay at the time of reading data can be reduced and the read performance of the memory system 1b can be improved.

For the rest, the memory system 1b of Embodiment 3 has the same effects as those of the memory system 1 of Embodiment 1 described above.

The configuration of Embodiment 3 may be used in combination with the configuration of Embodiment 1. That is, the data having a low rewrite frequency and a large size may be written into the designated region RA of Embodiment 1 and managed by the address conversion information 101 of Embodiment 1. Meanwhile, the data for which high-speed access is required with a very limited size may be managed with the address conversion information 101b of Embodiment 3 by setting the designated region RAb of Embodiment 3.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a first memory that is non-volatile; and
a controller that has a host interface and a second memory, and is configured to control the first memory, wherein the controller:
in response to a region designation command received from a host device along with consecutive logical addresses and a data size assigned thereto and a write command, sets a designated region having consecutive physical addresses in a storage region of the first memory, writes data corresponding to the consecutive logical addresses in the consecutive physical addresses, respectively, and stores in the second memory, first address conversion information in which a head physical address of the consecutive physical addresses is associated with a head logical address of the consecutive logical addresses and the data size, and
in response to a first read command received from the host device and the first read command has a logical address assigned thereto that correspond to data stored in the designated region, determines a physical address corresponding to the logical address assigned to the first read command, using the first address conversion information stored in the second memory.

2. The memory system according to claim 1,
wherein the controller determines the physical address based on a physical address offset from the head physical address specified in the first address conversion information, wherein the physical address offset is equal to an offset of the logical address assigned to the first read command from the head logical address specified in the first address conversion information.

3. The memory system according to claim 1, wherein
a logical-to-physical address conversion table is also stored in the storage region of the first memory, and the logical-to-physical address conversion table contains a plurality of mappings of logical addresses to physical addresses in a one-to-one manner, and
the controller, in response to a second read command received from the host device and the second read command has a logical address assigned thereto that correspond to data stored outside the designated region, reads the logical-to-physical address conversion table from the first memory and refers to the read logical-to-physical address conversion table to determine a physical address corresponding to the logical address assigned to the second read command.

4. The memory system according to claim 1,
wherein the controller, in response to the region designation command received from the host device along with consecutive logical addresses of data already written in the first memory, rewrites data already written in the first memory at new physical addresses that are consecutive in the storage region, and stores in the second memory, a second address conversion information in which a head of the new physical addresses is associated with a head of the consecutive logical addresses of the data already written.

5. The memory system according to claim 4, wherein
the controller, in response to a designated region check command received from the host device along with the consecutive logical addresses of data already written in the first memory, checks a state of an address conversion information related to the consecutive logical addresses and transmits a determination result to the host device, and
the designated region check command is received from the host device before the region designation command is received from the host device along with the consecutive logical addresses of data already written in the first memory.

6. The memory system according to claim 5, wherein
the designated region check command is received from the host device before a read command to which a logical address included in the consecutive logical addresses of data already written in the first memory is assigned, is received from the host device.

7. The memory system according to claim 1,
wherein the controller, in response to the region designation command received from the host device along with consecutive logical addresses of data already written in the first memory, does not rewrite the data already written in the first memory, when the data already written in the first memory are stored in consecutive physical addresses of the storage region.

8. The memory system according to claim 7, wherein
the controller, in response to a designated region check command received from the host device along with the consecutive logical addresses of data already written in the first memory, checks a state of an address conversion information related to the consecutive logical addresses and transmits a determination result to the host device, and
the designated region check command is received from the host device before the region designation command is received from the host device along with the consecutive logical addresses of data already written in the first memory.

9. The memory system according to claim 8,
wherein the designated region check command is received from the host device before a read command to which a logical address included in the consecutive logical addresses of data already written in the first memory is assigned, is received from the host device.

10. The memory system according to claim 1,
wherein the consecutive logical addresses assigned to the region designation command specify data having a rewrite frequency equal to or less than a predetermined value.

11. The memory system according to claim 1,
wherein the controller, in response to the region designation command received from the host device along with a logical address of data already written in the first memory, determines a physical address corresponding to the logical address and stores in the second memory, a second address conversion information in which the corresponding physical address is associated with the logical address and a data size of the data corresponding to the logical address.

12. The memory system according to claim 11, wherein the data size is of a predetermined logical unit size.

13. The memory system according to claim 11,
wherein the logical address assigned to the region designation command specify data having a required access speed equal to or more than a predetermined value.

14. A memory system comprising:
a first memory that is non-volatile; and
a controller that has a host interface and a second memory unit and is configured to control the first memory, wherein the controller:
in response to a region designation command received from a host device along with one or more logical addresses of data already written in the first memory, sets a region in which the data are already written as a designated region, determines physical addresses corresponding to the logical addresses, and stores address conversion information in which one physical address is associated with one logical address and a predetermined data size, and
in response to a read command received from the host device and the read command has a logical address assigned thereto that correspond to data stored in the designated region, determines a physical address corresponding to the logical address assigned to the read command using the address conversion information stored in the second memory.

15. The memory system according to claim 14,
wherein the predetermined data size is the data size of data corresponding to one logical address.

16. A host device connectable to a controller that controls a non-volatile memory,
wherein the host device transmits a region designation command to which consecutive logical addresses and a data size are assigned, to the controller, and
the logical addresses assigned to the region designation command specify data already written in the non-volatile memory or data to be newly written in the non-volatile memory.

17. The host device according to claim 16,
wherein the host device transmits a designated region check command to which the logical addresses corresponding to the data already written in the non-volatile memory is assigned, to the controller, before transmitting the region designation command to which the logical addresses that specify the data already written in the non-volatile memory, is assigned.

18. The host device according to claim 17,
wherein the host device transmits the designated region check command prior to transmitting a read command to which one of the logical addresses corresponding to the data already written in the non-volatile memory, is assigned.

19. The host device according to claim 16, wherein
the logical addresses assigned to the region designation command specify the data to be newly written in the non-volatile memory, and
the host device determines that a rewrite frequency of the data to be newly written in the non-volatile memory is equal to or less than a predetermined value.

20. The host device according to claim 16, wherein
the logical addresses assigned to the region designation command specify the data already written in the non-volatile memory, and
the host device determines that an access speed of the data already written in the non-volatile memory is required to be equal to or more than a predetermined value.
